(19) United States
(12) Patent Application Publication
(10) Pub. No.: US 2017/0021659 A1
(43) Pub. Date: Jan. 26, 2017

(54) Foldable Gift Card Mailer

(71) Applicant: Creative Communications LLC, DBA Mail America, Wheeling, WV (US)

(72) Inventor: Richard J Dlesk, Wheeling, WV (US)

(21) Appl. No.: 15/219,094

(22) Filed: Jul. 25, 2016

Related U.S. Application Data
(60) Provisional application No. 62/196,215, filed on Jul. 23, 2015.

(51) Int. Cl. B42D 15/08

(52) U.S. Cl. CPC B42D 15/08

(57) ABSTRACT

An apparatus for mailing a gift card contains a first card and a first removable card. The gift card is represented by the first removable card and is positioned within a first receiving slot. The first receiving slot is positioned across a first flap of the first card and traverses through the first flap. More specifically, the first removable card is perimetrically attached to the first flap such that the user can conveniently remove the gift card when necessary. The first card is provided with a second flap which allows the user to print mailing information and other product related details. If multiple gift cards are to be provided a second removable card can also be included with the apparatus. Similar, to the first removable card, the second removable card will also be perimetrically attached to the first flap.

The current application claims a priority to the U.S. Provisional Patent application Ser. No. 62/196,215 filed on Jul. 23, 2015. The current application is filed on Jul. 25, 2016 while Jul. 23, 2016 was on a weekend.

### FIELD OF THE INVENTION

The present invention relates generally to gift cards. In particular, the present invention introduces an apparatus that can be used as a gift card and also a mailing card. By utilizing the present invention, cost related to gift cards can be minimized. The present invention can come in various sizes, designs, and texts such that a large customer base can be reached.

### BACKGROUND OF THE INVENTION

Marketing may be extremely effective depending on the type of marketing given a specific audience. Marketing may also be quite expensive and drain the resources of a company if not properly implemented. Types of marketing include social media marketing, online advertising, direct mail and so on. The most effective and equally cost efficient marketing approach is direct mail. The main difficulty with direct mail is the need to immediately capture the attention of the consumer.

The use of gift cards has seen a significant increase over the recent past and has proven to be a very effective way of marketing. The convenience associated with the use of gift cards has been the main reason for the significant rise. Generally, a user purchases a gift card as a stored-value money card usually issued by a retailer or a bank to be used as an alternative to cash purchases within a store or business. However, if the gift card needs to be mailed, the user needs to take additional steps to mail the gift card which can be both time consuming and stressful. Therefore, the need for a convenient method of mailing out gift cards is clearly evident.

Another issue with gift cards is the inability to provide information regarding the store or bank associated with the gift card. The lack of display area to provide marketing material is the key reason for the inability. If more information can be provided with the gift card, the store or bank providing gift cards is provided with the ability to broaden their customer base.

As seen on many occasions, only a single gift card is provided with a single card. If a user intends on purchasing multiple gift cards, each of the gift cards need to be purchased separately. Individually, purchasing multiple gift cards can be financially disadvantageous to the user.

The objective of the present invention is to address the aforementioned issues. In particular, the present invention introduces an apparatus that contains a gift card and also another portion to include mailing information and other product related details. In addition to mailing information, advertising material can also be displayed by using the present invention.

### BRIEF DESCRIPTION OF THE DRAWINGS

FIG. 1 is a perspective view of the present invention.

FIG. 2 is a front view of the present invention.

FIG. 3 is a top view of the present invention.

FIG. 4 is an exploded view between the first removable card and the first card.

FIG. 5 is a perspective view of the present invention, wherein the first flap is folded along the first foldable edge.

FIG. 6 is a front view of the present invention, wherein the second removable card is also represented.

FIG. 7 is an exploded view of the first removable card and the second removable card.

FIG. 8 is a front view of the present invention, wherein the third flap is also illustrated.

### DETAIL DESCRIPTIONS OF THE INVENTION

All illustrations of the drawings are for the purpose of describing selected versions of the present invention and are not intended to limit the scope of the present invention.

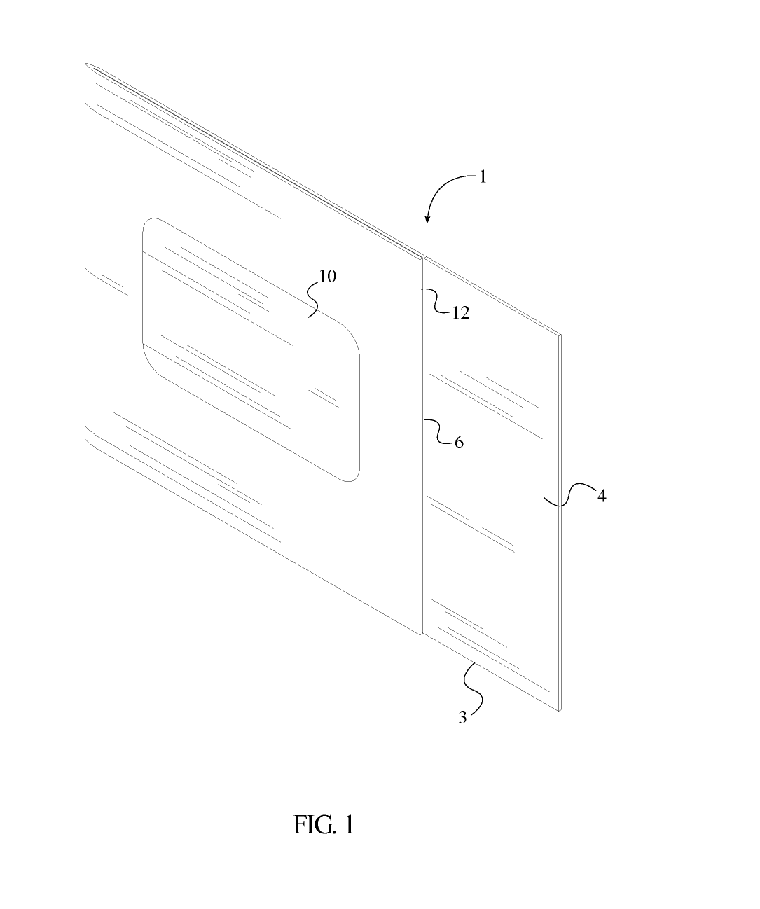

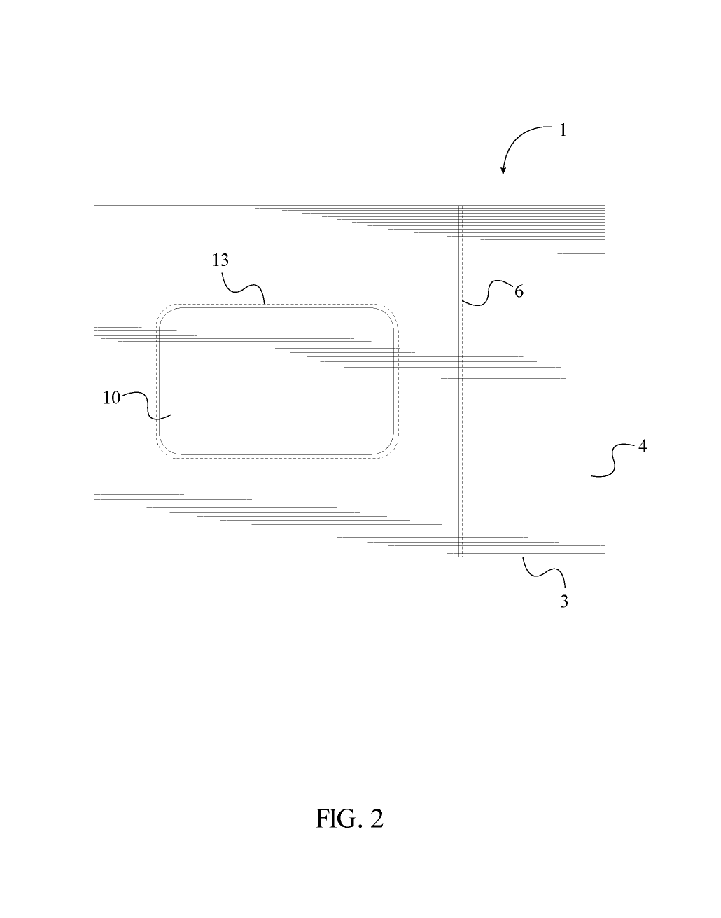

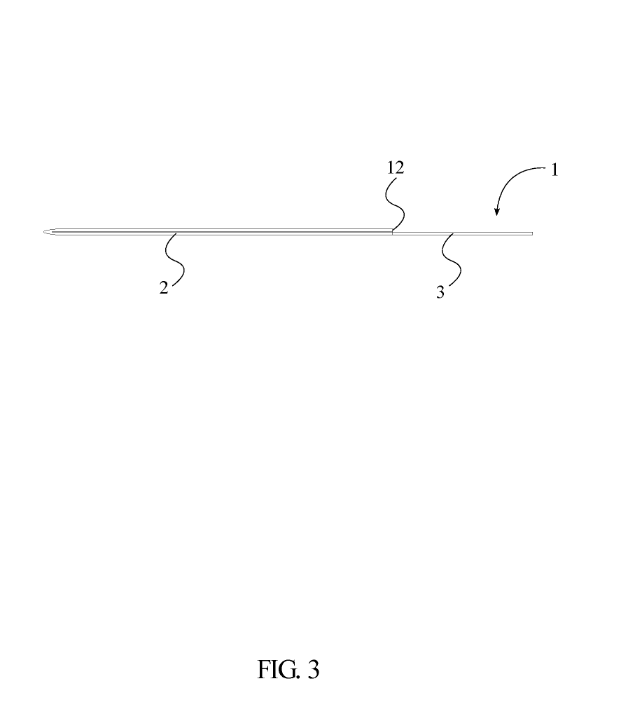

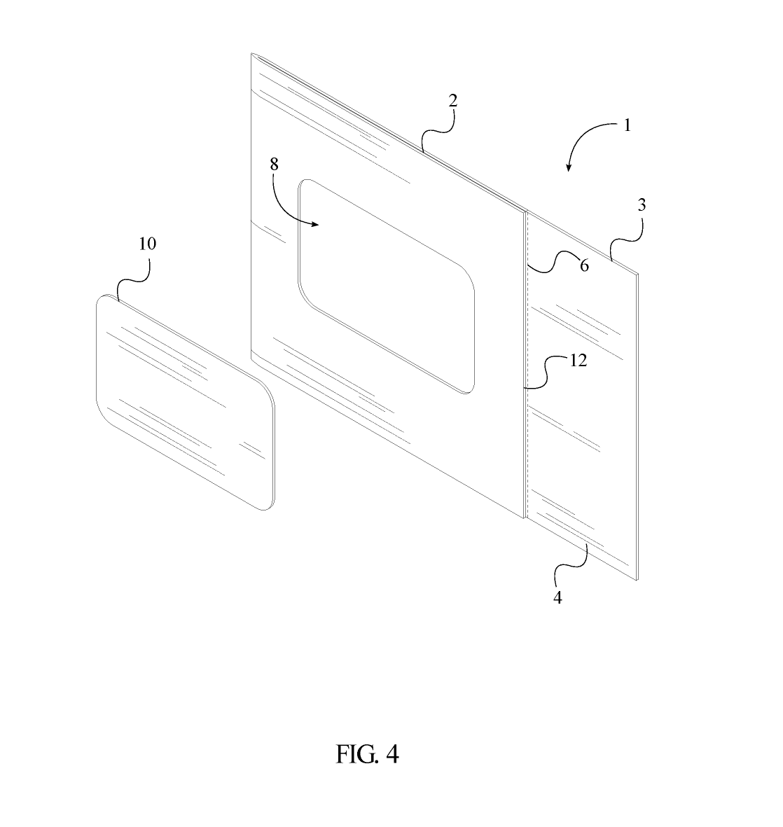

The present invention introduces a foldable gift card mailer. More specifically, the present invention is designed such that a gift card and mailing information can be included together. Resultantly, the need to use an envelope to mail out a gift card is eliminated. As an example, mailing information and product information can be included along with the gift card. The ability to display information helps a company promote a product with minimum financial investment. The present invention can be presented in different sizes and made with different material so that a larger customer base can be reached through the present invention. As illustrated in FIG. 1 and FIG. 2 the present invention comprises a first card 1, a first removable card 10, and a protective layer 12. In the preferred embodiment of the present invention the gift card is represented by the first removable card 10. The first removable card 10 is attached to the first card 1 so that the first removable card 10 can be removed when the need occurs. In addition to holding the first removable card 10, the first card 1 is also used to print mailing information and other product related details. In order to do so, the first card 1 comprises a first flap 2, a second flap 3, a first foldable edge 6, and a first receiving slot 8 as illustrated in FIG. 3 and FIG. 4. In the preferred embodiment of the present invention, the first card 1 is rectangular in shape giving the first flap 2 and the second flap 3 a rectangular shape as well. However, in different embodiments of the present invention, the shape and size of the first card 1 can vary. The first flap 2 and the second flap 3 is positioned such that the first flap 2 is foldably connected to the second flap 3 along the first foldable edge 6. The foldable connection allows the user to handle the first flap 2 and the second flap 3 individually. Therefore, the user can conveniently grab the first removable card 10 and also access the mailing information or other comparable information included with the first card 1. For mailing purposes and handling purposes, the first flap 2 and the second flap 3 are made of a lightweight material. However, the material properties can change in different embodiments of the present invention. As an example, the second flap 3 can be made of a material such as printing paper.

To provide user convenience, the first removable card 10 is positioned within the first receiving slot 8. In the preferred embodiment of the present invention, the first removable card 10 is centrally positioned on the first card 1. However, the first removable card 10 can be positioned differently in other embodiments of the present invention. As illustrated, the first receiving slot 8 is positioned across the first flap 2 and traverses through the first flap 2. Therefore, when positioned as required, the first removable card 10 is perimetrically attached to the first flap 2. The protective layer 12, is used to protect the present invention from being damaged during transportation. In order to do so, the first flap 2 is encased by the protective layer 12. More specifically, the first flap 2 is encased by the protective layer 12 such that the first removable card 10 is also encased by the protective layer 12. In the preferred embodiment of the present invention, the protective layer 12 is a laminated layer. The level of lamination can vary according to user preference. However, in different embodiments of the present invention other comparable protective layers can also be used.

When the need occurs, the first removable card 10 needs to be detached from the first flap 2 conveniently. More specifically, the first removable card 10 needs to be attached to the first flap 2 with an attachment mechanism that allows the user to separate the first removable card 10 from the first flap 2 effortlessly. In order to do so, the present invention comprises a plurality of perforations 13 which is positioned in between the first removable card 10 and the first flap 2. The first removable card 10 can also be attached via other comparable attachment mechanisms in other embodiments of the present invention.

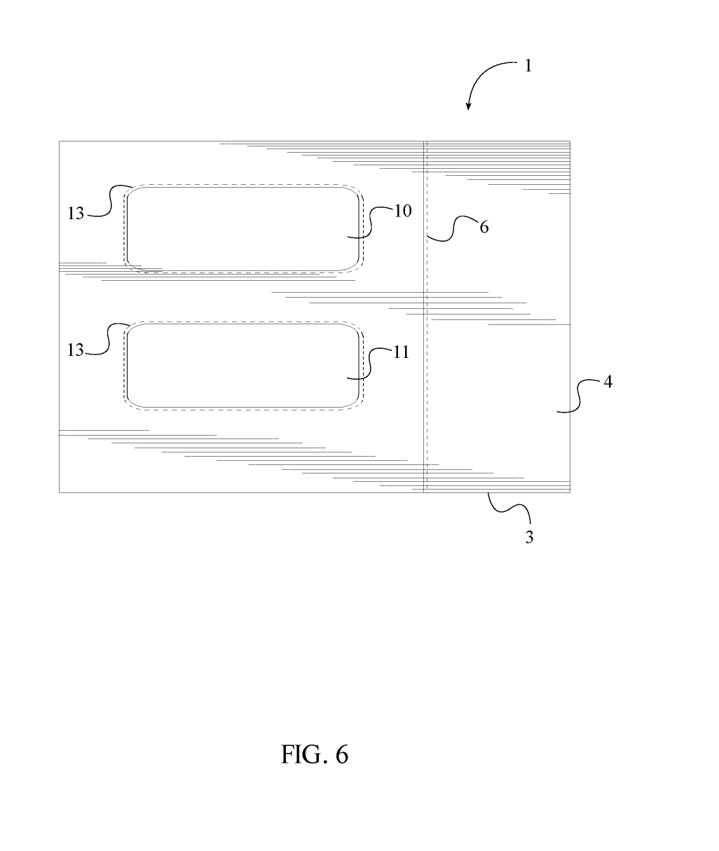

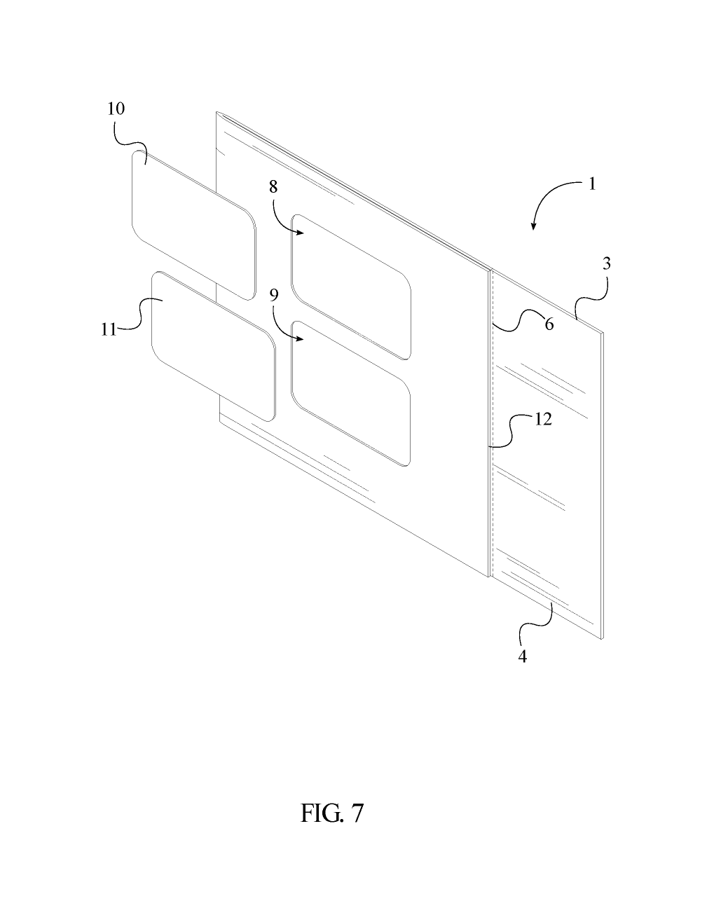

The present invention can also be used to hold multiple gift cards. As an example, if the present invention contains a second gift card, the present invention comprises a second removable card 11 as illustrated in FIG. 6. Similar to the first removable card 10, the second removable card 11 is positioned within a second receiving slot 9 and is perimetrically attached to the first flap 2. In order to do so, the first card 1 comprises a second receiving slot 9 which is positioned across the first flap 2 and also traverses through the first flap 2 as seen in FIG. 7. The second removable card 11 can be identical to the first removable card 10 or vary in size and shape.

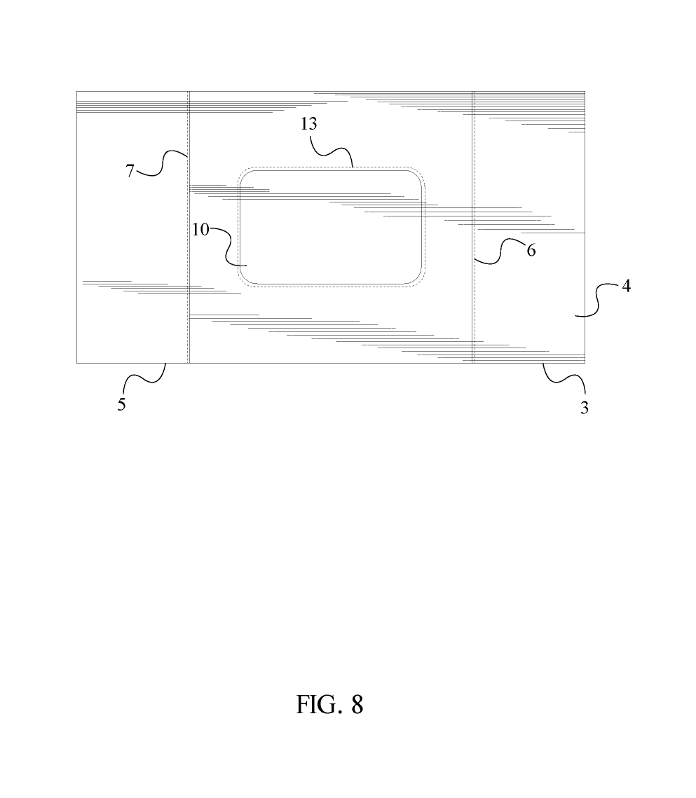

As mentioned earlier, the first flap 2 and the second flap 3 provides additional surface area to display promotional material and mailing information. In order to accommodate the promotional material and mailing information the second flap 3 comprises a printable surface area 4. Since the second flap 3 is not encased by the protective layer 12, the user can conveniently utilize the printable surface area 4. In another embodiment of the present invention the first card 1 can further comprise a second foldable edge 7 and a third flap 5 as shown in FIG. 8. In such instances, similar to the second flap 3, the third flap 5 can also be used to display mailing information and other product related details. In order to access the first flap 2, the second flap 3, and the third flap 5 individually, the first flap 2 is positioned in between the second flap 3 and the third flap 5. Moreover, the third flap 5 is foldably connected to the first flap 2 along the second foldable edge 7. In addition to using the third flap 5 for display purposes, the third flap 5 can also be used to hold a gift card in another embodiment of the present invention. For instance, the second removable card 11 can be perimetrically attached to the third flap 5 in another embodiment of the present invention. Since the gift card attached to the third flap 5 also needs to be protected, the third flap 5 is also encased by the protective layer 12.

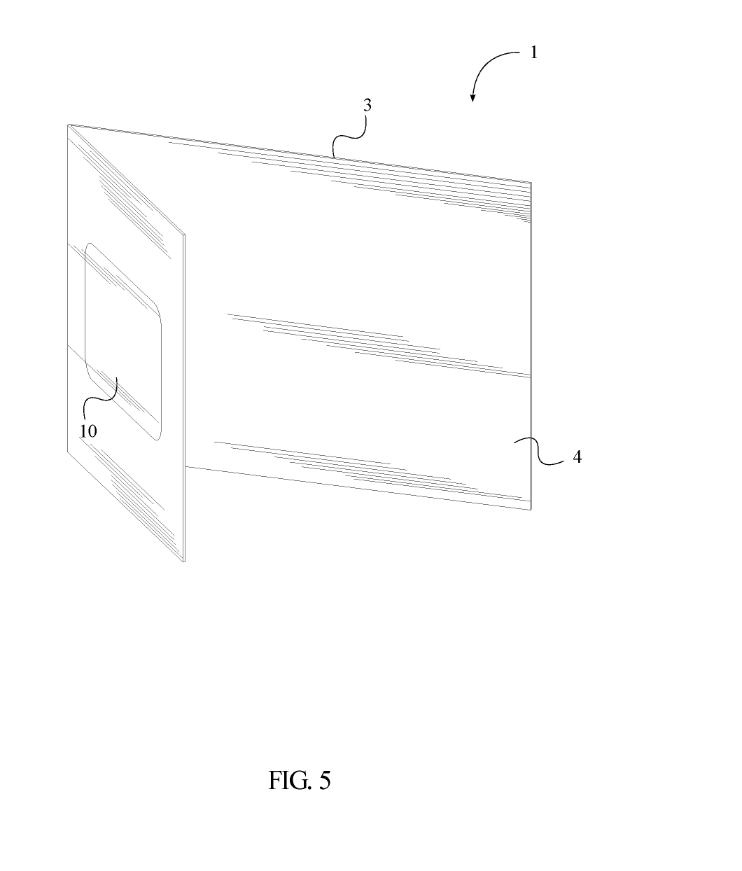

The first foldable edge 6 and the second foldable edge 7 allows the user to reduce the overall size of the present invention by folding the second flap 3. When the present invention is in a folded configuration as in FIG. 5, the second flap 3 is being positioned upon the first flap 2. In a different embodiment of the present invention, when the third flap 5 is also available, the third flap 5 is also positioned upon the first flap 2 and opposite the second flap 3. Since the second foldable edge 7 allows the third flap 5 to fold in two directions, the third flap 5 can also be positioned upon the first flap 2 and in between the first flap 2 and the second flap 3.

When utilizing the present invention, the following process flow is generally followed. As in the preferred embodiment of the present invention, if only the first removable card 10 is available, the first removable card 10 is positioned within the first receiving slot 8. The first flap 2 and the first removable card 10 will be encased by the protective layer 12 which is the laminated layer in the preferred embodiment of the present invention. Next, the user utilizes the second flap 3 to print mailing information or other comparable information. If available, the third flap 5 can also be used to print and display mailing information and other comparable details. The third flap 5 can also be used to position the second removable card 11 in another embodiment of the present invention. When the need arises, the user can conveniently detach the first removable card 10 and the second removable card 11 via the plurality of perforations 13.

Although the invention has been explained in relation to its preferred embodiment, it is to be understood that many other possible modifications and variations can be made without departing from the spirit and scope of the invention as hereinafter claimed.

What is claimed is:

1. A foldable gift card mailer comprises:
a first card;
a first removable card;
a protective layer;
the first card comprises a first flap, a second flap, a first foldable edge, and a first receiving slot;
the first flap being foldably connected to the second flap along the first foldable edge;
the first flap being encased by the protective layer;
the first receiving slot being positioned across the first flap;
the first receiving slot traversing through the first flap;
the first removable card being positioned within the first receiving slot; and
the first removable card being perimetrically attached to the first flap.

2. The foldable gift card mailer as claimed in claim 1 comprises:
a plurality of perforations; and
the plurality of perforations being positioned in between the first removable card and the first flap.

3. The foldable gift card mailer as claimed in claim 1 comprises:
a second removable card;
the first card further comprises a second receiving slot;
the second receiving slot being positioned across the first flap;
the second receiving slot traversing through the first flap;
the second removable card being positioned within the second receiving slot; and
the second removable card being perimetrically attached to the first flap.

4. The foldable gift card mailer as claimed in claim 1 comprises:
the first card further comprises a second foldable edge and a third flap;
the first flap being positioned in between the second flap and the third flap;
the third flap being foldably connected to the first flap along the second foldable edge; and
the third flap being encased by the protective layer.

5. The foldable gift card mailer as claimed in claim 1 comprises:
wherein the first card is in a folded configuration; and
the second flap being positioned upon the first flap.

6. The foldable gift card mailer as claimed in claim 4 comprises:
wherein the first card is in a folded configuration;
the second flap being positioned upon the first flap; and
the third flap being positioned upon the first flap and opposite the second flap.

7. The foldable gift card mailer as claimed in claim 4 comprises:
wherein the first card is in a folded configuration;
the second flap being positioned upon the first flap; and
the third flap being positioned upon the first flap and in between the first flap and the second flap.

8. The foldable gift card mailer as claimed in claim 1, wherein the protective layer is a laminated layer.

9. The foldable gift card mailer as claimed in claim 1, wherein the second flap comprises a printable surface area.

10. The foldable gift card mailer as claimed in claim 1, wherein the first removable card is centrally positioned on the first card.

11. The foldable gift card mailer as claimed in claim 1, wherein each of the first flap and the second flap is a lightweight material.

12. The foldable gift card mailer as claimed in claim 1, wherein the first card is rectangular in shape.
